(19) United States
(12) Patent Application Publication
(10) Pub. No.: US 2010/0033264 A1
(43) Pub. Date: Feb. 11, 2010

(54) ORTHOGONAL-MODE JUNCTION COUPLER WITH AN ULTRABROAD OPERATING BANDWIDTH

(76) Inventors: Lars Foged, Apilia (IT); Andrea Giacomini, Albano Laziale (Rome) (IT); Luc Duschesne, Angervilliers (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/446,975

(22) PCT Filed: Oct. 18, 2007
(86) PCT No.: PCT/EP2007/061133

§ 371 Date: Apr. 23, 2009

(30) Foreign Application Priority Data
Oct. 24, 2006 (FR) 06 09333

(51) Int. Cl. H01P 1/161

(52) U.S. Cl. 333/109

(57) ABSTRACT

The present invention relates to an orthogonal-mode junction coupler with an ultrabroad bandwidth or a wavelength waveguide noteworthy in that it includes what is called an external conductor (8) comprising a cavity (9) in which a central conductor (10) extends, said central conductor being electrically isolated at radiofrequencies with the external conductor (8), said central conductor (10) being supplied by supply lines (15, 16, 17, 18) passing through the external conductor (8) and emerging in the cavity (9) of said external conductor (8).

The present invention concerns an orthogonal-mode junction coupler with an ultrabroad operating bandwidth to separate dual-polarization bands spreading in a horn antenna, for example.

In the field of radiofrequency antennas, it is well known to use orthogonal-mode junction couplers, or “ortho-mode junction” (OMJ) couplers, to separate dual-polarization bands.

For very broad operating frequency bands, these ortho-mode junction couplers are traditionally made up of a supply section of the waveguide in the shape of a cross comprising two central supply points, one supply point for each polarization, placed along the axis of the coupler, said points being offset along the axis of the coupler and ending with shield cavities in the rear.

This type of coaxial coupler has the drawback of being bulky and providing poor insulation between the two inlet ports of the supply points which are close to each other.

Furthermore, this type of coupler has an asymmetry which leads to degradation of the purity of the modal network due to the excitation of higher order modes.

One of the aims of the invention is therefore to resolve all of these drawbacks by proposing a particularly compact OMJ coupler with an ultrabroad bandwidth providing weak coupling between the input ports as well as a particularly stable ultrabroad bandwidth single-mode and bi-polarized excitation.

According to the invention, what is proposed is an orthogonal-mode junction coupler with an ultrabroad bandwidth for a wavelength λ waveguide which is remarkable in that it comprises a so-called external conductor comprising a cavity in which a central conductor projects, said central conductor being electrically isolated at radiofrequencies with the external conductor, said central conductor being supplied by supply lines passing through the external conductor and emerging in the cavity of the external conductor.

Said central conductor has a transverse cross-shaped section preferably having two orthogonal axes of symmetry.

Furthermore, the orthogonal-mode junction coupler according to the invention comprises four supply lines emerging in the cavity of the external conductor, each supply line being connected to a branch of the cross-shaped central conductor.

Preferably, each supply line is connected to a branch of the central conductor by an ohmic contact.

Two branches opposite the central conductor are supplied with radiofrequency signals by two opposite supply lines, respectively, to trigger a given polarization.

To this end, the supply lines are connected to an external supply circuit determining the phase distribution of each signal sent by the supply lines.

According to one essential characteristic of the invention, the supply lines are connected to the central conductor in a same plane orthogonal to the axis of the central conductor.

Other advantages and characteristics will better emerge from the description which follows, of a single embodiment provided as a non-limiting example, of the orthogonal-mode junction coupler with an ultrabroad bandwidth, in particular a coaxial coupler, according to the invention, from the appended drawings in which:

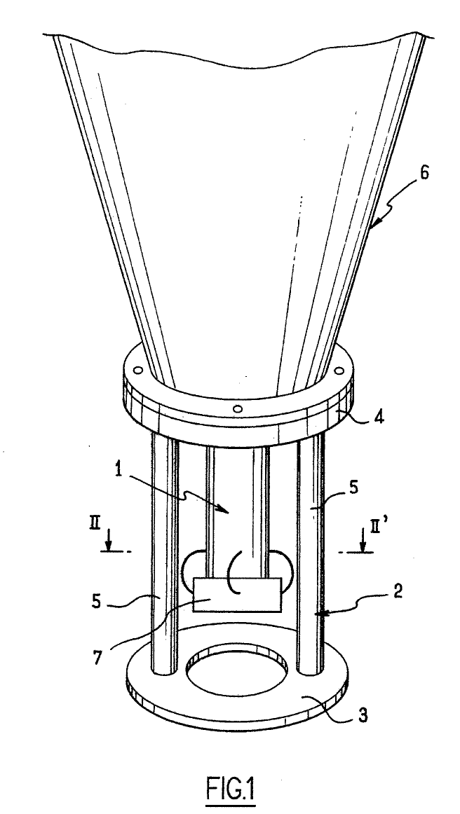

FIG. 1 is a perspective view of the coaxial OMJ coupler with an ultrabroad bandwidth according to the invention coupled to a horn antenna,

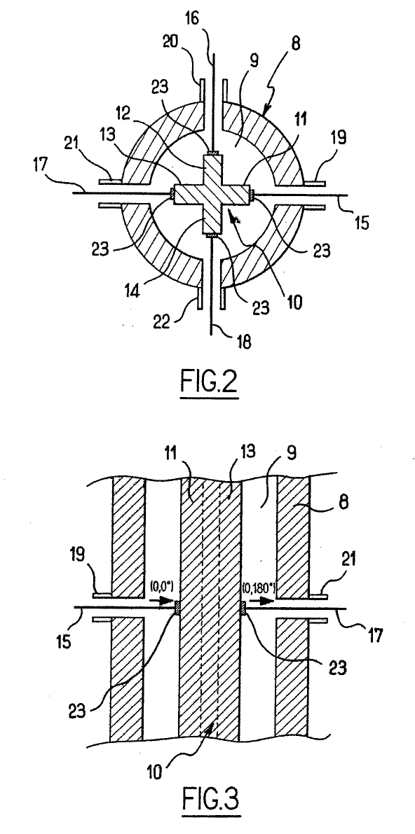

FIG. 2 is a diagrammatic transverse cross-sectional view of the coaxial OMJ coupler with an ultrabroad bandwidth according to the invention,

FIG. 3 is a diagrammatic longitudinal cross-sectional view of the coaxial OMJ coupler with an ultrabroad bandwidth according to the invention.

Below we will describe an OMJ coupler with an ultrabroad bandwidth according to the invention in order to separate the orthogonal dual-polarization bands of a circular feed horn coaxial to or charged from a dielectric cone; however, it is obvious that the coupler according to the invention may be used alone and/or in any other application well known by One Skilled in the Art.

In reference to FIG. 1, the OMJ coupler 1 with an ultrabroad bandwidth according to the invention is supported by a support frame 2 made up of two crowns, a lower crown 3 and an upper crown 4 connected by spacers 5 in the form of cylindrical columns, the upper crown 4 supporting a horn antenna 6. The support frame 2 also supports an external supply circuit 7 of the coupler 1 which will be explained in detail later.

Said coupler 1, in reference to FIGS. 2 and 3, comprises a so-called external conductor 8 comprising a cavity 9 in which a central conductor 10 extends, said central conductor being electrically isolated at radiofrequencies with the external conductor 8. One will note that the central conductor is not electrically isolated at pulsed current.

The external conductor 8 consists of a cylindrical tube having a coaxial cylindrical cavity 9.

Furthermore, the central conductor 10 has a cross-shaped transverse section comprising two orthogonal axes of symmetry. Thus, the central conductor 10 comprises four branches 11, 12, 13 and 14, opposite each other in pairs.

Furthermore, each branch 11, 12, 13 and 14 of said central conductor 10 is supplied by supply lines 15, 16, 17 and 18, respectively, passing through the external conductor 8 by inlet ports 19, 20, 21 and 22 and emerging into the cavity 9 of the external conductor 8.

Each supply line 15, 16, 17 and 18 is connected to a branch 11, 12, 13 and 14, respectively, of the central conductor 10 by an ohmic contact 23. Said ohmic contact 23 will be obtained through any suitable means well known by One Skilled in the Art.

Particularly advantageously, the supply lines 15, 16, 17 and 18 are connected to each of the branches 11, 12, 13 and 14, respectively, of the central conductor 10 in a same plane orthogonal to the longitudinal axis of said central conductor 10.

Furthermore, the supply lines 15, 16, 17 and 18 are connected to the external supply circuit 7 determining the phase distribution of each signal sent by said supply lines 15, 16, 17 and 18. Said supply circuit 7 supplies two opposite branches, for example branches 11 and 13, of the central conductor 10 with radiofrequency signals by the two respective opposite supply lines 15 and 17, respectively, in order to trigger a determined polarization. For example, the supply circuit 7 supplies the branches 11 and 13 with radiofrequency signals having the phase distributions (0,0°) and (0, 180°), respectively, in order to trigger a polarization of the branches 11 and 13 as diagrammatically illustrated by arrows in FIG. 3.

One will note that the electric symmetry of the coaxial OMJ coupler with an ultrabroad bandwidth according to the invention provides a stable single-mode and bi-polarized excitation with an ultrabroad bandwidth as well as weak coupling between the inlet ports of the supply lines. This weak coupling between the inlet ports makes it possible to do without an external compensating circuit.

Furthermore, the coaxial OMJ coupler with an ultrabroad bandwidth according to the invention is particularly compact given that the supply lines 15, 16, 17 and 18 are connected to each of the branches 11, 12, 13 and 14, respectively, of the central conductor 10 in a same plane orthogonal to the longitudinal axis of said central conductor 10.

It is quite clear that the coupler according to the invention may be obtained according to a precision trimming method well known by One Skilled in the Art or a method for manufacturing a multi-layer printed circuit, said multi-layer printed circuit being integrated into a waveguide, without, however, going beyond the scope of the invention. One will observe that, for a coupler obtained according to a printed circuit manufacturing method, the supply lines will be able to have an opposite direction.

Lastly, it goes without saying that the coaxial OMJ coupler with a medium or ultrabroad bandwidth according to the invention may be adapted for any other application well known by One Skilled in the Art and that the examples we have provided are in no way limiting as to the fields of application of the invention.

1. An orthogonal-mode junction coupler with an ultrabroad bandwidth of a wavelength λ waveguide characterized in that it comprises a so-called external conductor (8) comprising a cavity (9) in which a central conductor (10) extends, said central conductor being electrically isolated at radiofrequencies with the external conductor (8), said central conductor (10) being supplied by supply lines (15, 16, 17, 18) passing through the external conductor (8) and emerging in the cavity (9) of said external conductor (8).

2. The orthogonal-mode junction coupler according to claim 1 characterized in that the central conductor (10) has a cross-shaped transverse section.

3. The orthogonal-mode junction coupler according to claim 1 characterized in that the central conductor (10) has two orthogonal axes of symmetry.

4. The orthogonal-mode junction coupler according to any one of claims 2 or 3 characterized in that it comprises four supply lines (15, 16, 17, 18) emerging in the cavity (9) of the external conductor (8), each supply line (15, 16, 17, 18) being connected to a branch (11, 12, 13, 14) of the cross-shaped central conductor (10).

5. The orthogonal-mode junction coupler according to any one of claims 1 to 4 characterized in that each supply line (15, 16, 17, 18) is connected to a branch (11, 12, 13, 14) of the central conductor (10) by an ohmic contact (23).

6. The orthogonal-mode junction coupler according to any one of claims 4 or 5 characterized in that two branches (11, 12, 13, 14) opposite the central conductor (10) are supplied with radiofrequency signals by two opposite supply lines (15, 16, 17, 18), respectively, in order to trigger a determined polarization.

7. The orthogonal-mode junction coupler according to any one of claims 2 to 6 characterized in that the supply lines (15, 16, 17, 18) are connected to an external supply circuit (7) determining the phase distribution of each signal sent by the supply lines (15, 16, 17, 18).

8. The orthogonal-mode junction coupler according to any one of claims 1 to 7 characterized in that the supply lines (15, 16, 17, 18) are connected to the central conductor (10) in a same plane.

9. The orthogonal-mode junction coupler according to claim 7 characterized in that the plane in which the connections of the supply lines (15, 16, 17, 18) to the central conductor (10) extend is orthogonal to the axis of the central conductor (10).
